(19) United States
(12) Patent Application Publication
(10) Pub. No.: US 2024/0425991 A1
(43) Pub. Date: Dec. 26, 2024

(54) MANGANESE OXIDE OVER NICKEL FOAM AS AN ELECTROCATALYST FOR WATER OXIDATION

(71) Applicant: KING FAHD UNIVERSITY OF PETROLEUM AND MINERALS, Dhahran (SA)

(72) Inventors: Muhammad Ali EHSAN, Dhahran (SA); Abbas Saeed HAKEEM, Dhahran (SA)

(73) Assignee: KING FAHD UNIVERSITY OF PETROLEUM AND MINERALS, Dhahran (SA)

(21) Appl. No.: 18/340,094

(22) Filed: Jun. 23, 2023

(51) Int. Cl. C25B 1/04; C25B 11/031; C25B 11/054; C25B 11/061; C25B 11/079

(52) U.S. Cl. CPC C25B 1/04; C25B 11/031; C25B 11/054; C25B 11/061; C25B 11/079

(57) ABSTRACT

A method of generating oxygen including applying a potential of greater than 0 to 2.0 V to an electrochemical cell that is at least partially submerged in an aqueous solution such that on applying the potential the aqueous solution is oxidized thereby forming oxygen. The electrochemical cell includes an electrocatalyst and a counter electrode. The electrocatalyst includes a nickel foam substrate and a layer of particles of manganese oxide having a formula of MnₓO_{y} on a surface of the nickel foam substrate, where x is an integer from 1 to 7, and where y is an integer from 1 to 13. The particles of MnO have a spherical shape with an average diameter of 5-15 nanometers (nm) and are aggregated with an average aggregate size of 500-1,000 nm in the shape of a cauliflower.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to an electrocatalyst, particularly to manganese oxide fabricated over nickel foam and use of the electrocatalyst as an electrocatalyst for water oxidation.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Developing renewable energy systems remains a research focus to fulfill growing energy needs without harming the environment. In this regard, hydrogen is considered a promising energy-rich fuel, capable of operating fuel cells, aircraft, power stations, and the chemical industry, without emitting greenhouse (GHG) gases. Electrocatalytic water splitting is a method of producing hydrogen which includes two half-cell reactions of hydrogen evolution reaction (HER) and oxygen evolution reaction (OER) at the cathode and anode, respectively. However, OER is considered difficult due to a high kinetic barrier, and efficient catalysts are required to improve the reaction rate of the OER. IrO₂ and RuO₂ exhibit the best catalytic activity among the various OER catalysts, however, their high price and scarcity make the water-splitting process economically non-viable. Hence, developing low-priced, earth-abundant catalysts with high activity is necessary.

Therefore, catalysts including 3d-transition metals, such as Mn, Fe, Co, Ni, and Cu have been developed. Various combinations of these metals and their oxides, sulfides, layered double hydroxides, and binary alloys, have been engineered and studied for OER catalysis. Manganese (Mn) is a unique element among transition metals because of its ease of existence, abundance, limited toxicity, and low cost. In addition, the chemistry of manganese oxides (MnₓO_{y}) is enriched with structural diversity as its various compounds, including MnO, MnO₂, Mn₂O₃, and Mn₃O₄, demonstrate multiple applications in catalysis, energy storage, and fuel cells. In MnₓO_{y}-based compounds, Mn possesses multiple oxidation states, enabling these materials to adsorb many electrolyte ions, thus expediting the oxidation process during water electrolysis. Despite advances in MnO-based catalysts, there is still great interest in improving the catalytic activity and stability by modifying the preparation and morphology of the catalyst.

In view of the forgoing, one objective of the present invention is to provide an electrocatalyst including MnO. It is another object of the present disclosure to provide a MnO electrocatalyst with a cheap and efficient method of making.

### SUMMARY

In an exemplary embodiment, a method of generating oxygen is described. The method includes applying a potential of greater than 0 to 2.0 V to an electrochemical cell, wherein the electrochemical cell is at least partially submerged in an aqueous solution, wherein on applying the potential, the aqueous solution is oxidized, thereby forming oxygen. The electrochemical cell includes an electrocatalyst; and a counter electrode. The electrocatalyst includes a nickel foam substrate; and a layer of particles of manganese oxide having a formula of MnₓO_{y} on a surface of the nickel foam substrate, wherein x is an integer from 1 to 7, and wherein y is an integer from 1 to 13. The particles of MnO have a spherical shape with an average diameter of 5-15 nanometers (nm), and the particles of MnO are aggregated with an average aggregate size of 500-1,000 nm in the shape of a cauliflower.

In some embodiments, a method of forming the electrocatalyst is described. The method includes mixing a manganese salt in a solvent to form a homogeneous solution, and depositing the homogeneous solution on the nickel foam substrate by aerosol-assisted chemical vapor deposition (AACVD) at a temperature of 400-600° C. to form the electrocatalyst.

In some embodiments, the method includes depositing the homogeneous solution on the nickel foam substrate for 30-60 minutes.

In some embodiments, the method includes depositing the homogeneous solution on the nickel foam substrate at atmospheric pressure.

In some embodiments, the particles of manganese oxide have a formula of MnO.

In some embodiments, the MnO has a cubic structure having a space group of Fm3m.

In some embodiments, the MnO is polycrystalline.

In some embodiments, the particles of manganese oxide consist of Mn and O.

In some embodiments, the particles of manganese oxide are homogeneously dispersed on the surface of the nickel foam substrate.

In some embodiments, the particles of manganese oxide cover an entire surface of the nickel foam substrate.

In some embodiments, the particles of manganese oxide penetrate the micropores of the nickel foam substrate.

In some embodiments, the particles of manganese oxide form a continuous network on the surface of the nickel foam substrate.

In some embodiments, the electrocatalyst has an overpotential of 140-160 millivolts (mV) for a current density of 10 milliamperes per square centimeter (mA cm⁻²).

In some embodiments, the overpotential does not vary by more than 5% after the potential is applied for 2-50 hours.

In some embodiments, the electrocatalyst has a current density of at least 1,000 mA cm⁻² at 430 mV.

In some embodiments, the electrocatalyst consists of particles of manganese oxide on the surface of the nickel foam substrate.

In some embodiments, the aqueous solution includes at least one base selected from the group consisting of an alkaline earth metal hydroxide and an alkali metal hydroxide.

In some embodiments, the base is potassium hydroxide.

In some embodiments, the counter electrode is made from a material selected from the group consisting of platinum, gold, and carbon.

The foregoing general description of the illustrative present disclosure and the following The detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of preparing an electrocatalyst, according to certain embodiments;

FIG. 2 is X-ray diffraction patterns of manganese (II) oxide (MnO) thin films deposited on a nickel foam (NF) for 30 minutes (MnO@NF-30), and 60 minutes, (MnO@NF-60), respectively, according to certain embodiments;

FIGS. 3A and 3B show field emission scanning electron (FE-SEM) micrographs of the nickel foam, at different magnifications, according to certain embodiments;

FIG. 3C and FIG. 3D show FE-SEM micrographs of MnO thin films directly grown on nickel foam at 30 minutes, at different magnifications, according to certain embodiments;

FIG. 3E and FIG. 3F show FE-SEM micrographs of MnO thin films directly grown on nickel foam at 60 minutes, at different magnifications, according to certain embodiments;

FIG. 4A and FIG. 4B shows energy dispersive X-ray spectroscopic (EDX) images of MnO thin film samples grown by aerosol-assisted chemical vapor deposition (AACVD) technique for 30 minutes, according to certain embodiments;

FIG. 4C and FIG. 4D show EDX images of MnO thin film samples grown by AACVD technique for 60 minutes, according to certain embodiments;

FIG. 5A and FIG. 5B show a high resolution-transmission electron microscopy (HR-TEM) micrographs of MnO thin film samples grown for 60 minutes on NF, at different resolutions, according to certain embodiments;

FIG. 5C shows HR-TEM of MnO sphere presenting the lattice fringes, according to certain embodiments;

FIG. 5D shows selected area (electron) diffraction (SAED) patterns showing ring formation for a polycrystalline nature of MnO, according to certain embodiments;

FIG. 6A shows a survey scan and high-resolution representing photoelectron peaks in an X-ray photoelectron (XPS) spectra of thin film samples grown for 60 minutes on NF by the AACVD technique, according to certain embodiments;

FIG. 6B shows XPS binding energies of Mn 2p_{3/2} and Mn 2p_{1/2} for the oxides Mn, according to certain embodiments;

FIG. 6C shows XPS binding energies for O 1s for the oxides Mn, according to certain embodiments;

FIG. 7A shows consecutive 1^{st} and 80^{th} cyclic voltammetry (CV) scans for the MnO@NF-30 catalyst conducted at a scan rate of 50 mV/sec in 1.0 M KOH, according to certain embodiments;

FIG. 7B shows 1^{st} and 80^{th} CV scans for the MnO@NF-60 catalyst conducted at a scan rate of 50 mV/sec in 1.0 M KOH, according to certain embodiments;

FIG. 7C is a graph showing a comparison of 80^{th} CV scans for the MnO@ NF-30 and the MnO@ NF-60 catalysts, according to certain embodiments;

FIG. 8A shows an oxygen evolution reaction (OER) analysis by studying linear sweep voltammetric (LSV) profiles, current density vs. potential (RHE) of MnO@NF-60, MnO@NF-30, and bare nickel foam substrate (bare@NF) films in 1.0 M KOH electrolyte solution at pH=14, according to certain embodiments;

FIG. 8B shows OER onset potential analysis plotted against maximum current density (J) of the MnO@NF-60, MnO@NF-30, and bare@NF films, according to certain embodiments;

FIG. 8C shows current density (mA/cm²) profiles of the MnO@NF-60, MnO@NF-30, and bare@NF films from estimating their decade value to the maximum and corresponding overpotentials, according to certain embodiments;

FIG. 8D shows Tafel slope determination from the polarization curves obtained from the MnO@NF-60, MnO@NF-30, and bare@NF films, according to certain embodiments;

FIG. 9A shows Electrochemical Impedance Spectroscopy (EIS) investigations showing Nyquist plots of the MnO@NF-60, MnO@NF-30, and bare@NF prepared by AACVD, according to certain embodiments;

FIG. 9B shows a comparative analysis of charge transfer resistance and exchange current density of the MnO@NF-60, MnO@NF-30, and bare@NF, according to certain embodiments;

FIG. 9C shows a turnover frequency (TOF) of the MnO@NF-60, MnO@NF-30, and bare@NF measured at various potentials directly from polarization curves, according to certain embodiments;

FIG. 9D shows mass activity of the MnO@NF-60, MnO@NF-30, and bare@NF electrocatalyst, according to certain embodiments;

FIG. 9E shows an electrochemical active surface area (ECSA) and specific activity of the MnO@NF-60 and MnO@NF-30 electrocatalysts, according to certain embodiments;

FIG. 10A shows CV conducted at varying scan rates (from 10 mV s¹⁻ to 70 mV s¹⁻) in the non-faradaic regions, according to certain embodiments;

FIG. 10B is a plot of current density measured at a fixed potential intended as a function of scan rate, according to certain embodiments;

FIG. 10C shows ECSA for the MnO@NF-30 electrocatalyst in 1.0 M KOH electrolyte solution conducted at various scan rates (from 10 mV s¹⁻ to 70 mV s¹⁻) in the non-faradaic regions, where the current density observed is due to capacitive charging only, according to certain embodiments;

FIG. 10D shows charging current at a fixed potential as a function of scan rate, according to certain embodiments;

FIG. 11A shows chronopotentiometry measurements showing (f vs. t) profile of the MnO@NF-60 electrocatalyst at 25 and 50 mA/cm² of applied current densities in 1.0 M KOH electrolyte, according to certain embodiments; and

FIG. 11B shows LSV polarization curves obtained from the MnO@NF-60 electrocatalyst catalyst before and after the stability measurements under the same reaction conditions, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

As used herein, the words “about,” “approximately,” or “substantially similar” may be used when describing magnitude and/or position to indicate that the value and/or position described is within a reasonable range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values).

Within the description of this disclosure, where a numerical limit or range is stated, the endpoints are included unless stated otherwise. Also, all values and subranges within a numerical limit or range are specifically included as if explicitly written out.

As used herein, “particle size” and “pore size” may be thought of as the lengths or longest dimensions of a particle and of a pore opening, respectively.

As used herein, the term “electrode” refers to an electrical conductor used to contact a non-metallic part of a circuit e.g., a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “aerosolizing” refers to a process of intentionally oxidatively converting solution for the purpose of delivering the oxidized aerosols to the heating chamber.

As used herein, the term “aerosol” refers to extremely small solid particles, or very small liquid droplets, suspended in a gaseous atmosphere.

As used herein, the term “electrochemical cell” refers to a device capable of either generating electrical energy from chemical reactions or using electrical energy to cause chemical reactions.

As used herein, the term “water splitting” refers to the chemical reaction in which water is broken down into oxygen and hydrogen.

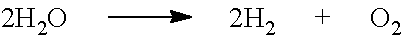

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁴Ni. Isotopes of manganese ²⁵Mn include ⁴⁶Mn, ⁴⁷Mn, ⁴⁸Mn, ⁴⁹Mn, ⁵⁰Mn, ⁵¹Mn, ⁵²Mn, ⁵³Mn, ⁵⁴Mn, ⁵⁵Mn, ⁵⁶Mn, ⁵⁷Mn, ⁵⁸Mn, ⁵⁹Mn, ⁶⁰Mn, ⁶¹Mn, ⁶²Mn, ⁶³Mn, ⁶⁴Mn, ⁶⁵Mn, ⁶⁶Mn, ⁶⁷Mn, ⁶⁸Mn, ⁶⁹Mn, ⁷⁰Mn, ⁷¹Mn, ⁷²Mn, and ⁷³Mn. Isotopes of oxygen include ¹⁶O, ¹⁷O, and ¹⁸O Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to the development of earth-rich, noble-metal-free, and highly electroactive catalysts to accelerate the oxygen evolution reaction (OER) of water-splitting technologies. The method of the present disclosure is a cost-effective and simple strategy to fabricate MnO electrocatalysts for water splitting.

According to an aspect of the present disclosure, an electrocatalyst, also referred to as a catalyst, is described. The electrocatalyst includes a substrate onto which is dispersed a layer of metallic particles. In an embodiment, the substrate is made from at least one metal selected from the group consisting of Mn, Fe, Co, and Ni. In an embodiment, the substrate is in the form of a foam, a mesh, or a solid metal sheet. As used herein a metal foam is a cellular structure consisting of a solid metal with gas-filled pores comprising a large portion of the volume. In a preferred embodiment, the substrate is nickel foam (NF). In an embodiment, at least 80-99% of the nickel foam substrate is porous, preferably 85%, 90%, or 95%. In an embodiment, the average pore size of the NF substrate is about 50 to 500 micrometers (μm), preferably 100-400 μm, or about 200-300 μm. In an embodiment, the substrate has a thickness of 0.1 to 10 mm, preferably 0.5 to 8 mm, 1 to 5 mm or 2-3 mm. Also, the pores may have many shapes, such as cubical, conical, cuboidal, pyramidical, or cylindrical. In an embodiment, the pores of the NF substrate have a spherical shape.

The electrocatalyst further includes a layer of particles of manganese oxide having a formula of MnₓO_{y} on the surface of the substrate, where x is an integer from 1 to 7, preferably 2 to 6, 3 to 5, or 4, and where y is an integer from 1 to 13, preferably 2 to 12, 3 to 11, 4 to 10, 5 to 9, 6 to 8, or 7. Suitable examples of manganese oxide include, manganese(II) oxide (MnO), manganese(II,III) oxide (Mn₃O₄), manganese(III) oxide (Mn₂O₃), manganese dioxide (MnO₂), manganese(VI) oxide (MnO₃), manganese(VII) oxide (Mn₂O₇), Mn₅O₈, Mn₇O₁₂, Mn₇O₁₃, and combinations thereof. In some embodiments, the manganese oxide particles include another transition metal selected from the group consisting of scandium, titanium, vanadium, chromium, iron, cobalt, copper, and zinc. In a preferred embodiment, the particles of manganese oxide consist of Mn and O.

In a preferred embodiment, the particles of manganese oxide have a formula of MnO. In some embodiments, the MnO has a cubic, triclinic, monoclinic, orthorhombic, tetragonal, trigonal, or hexagonal structure. In a preferred embodiment, the MnO has a cubic structure. In a preferred embodiment, the MnO has a cubic structure and a space group of Fm3m. In some embodiments, the MnO is crystalline, amorphous, or polycrystalline. In a preferred embodiment, the MnO is polycrystalline.

In some embodiments, the electrocatalyst includes a co-catalyst. In an especially preferred embodiment, the electrocatalyst does not include a co-catalyst. As used herein, the term ‘co-catalyst’ refers to the substance or agent that brings about catalysis in conjunction with one or more others. In a more preferred embodiment, the co-catalyst does not include platinum. In the most preferred embodiment, the co-catalyst does not include any noble metals such as gold, silver, ruthenium, rhodium, palladium, osmium, iridium, and platinum. In a more preferred embodiment, the substrate and catalyst do not include platinum. In the most preferred embodiment, the substrate and catalyst do not include any noble metals such as gold, silver, ruthenium, rhodium, palladium, osmium, iridium, and platinum. In a preferred embodiment, the electrocatalyst consists of manganese oxide on the surface of the nickel foam substrate.

In some embodiments, the manganese oxide particles are in the form of spheres. In some embodiments, the manganese particles may exist in other morphological forms such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanofloweres, etc. and mixtures thereof. In some embodiments, the spheres have an average diameter of 5-15 nanometers (nm), preferably 6, 7, 8, 9, 10, 11, 12, 13, or 14 nm. In some embodiments, the spheres are aggregated to form aggregates with an average size of 500-1,000 nm, preferably 600-900 nm, or 700-800 nm. In some embodiments, the aggregates are in the shape of a cauliflower. For example, protruding from the substrate surface there are adjacent clusters of particles. In some embodiments, the clusters touch one another. In some embodiments, the clusters are spaced 10-100 nm apart, preferably 20-90 nm, 30-80 nm, 40-70 nm, or 50-60 nm.

In some embodiments, the particles of manganese oxide are homogeneously dispersed on the surface of the nickel foam substrate. In some embodiments, the particles of manganese oxide form a continuous network on the surface of the nickel foam substrate. In some embodiments, the particles of manganese oxide cover at least 50%, preferably 60%, 70%, 80%, 90%, or the entire surface of the nickel foam substrate. In some embodiments, the NF substrate in addition to the pores of 50 to 500 μm in size, has micropores with an average size of 5-50 nm, preferably 10-40 nm, or 20-30 nm. In some embodiments, the particles of manganese oxide penetrate the micropores of the nickel foam substrate.

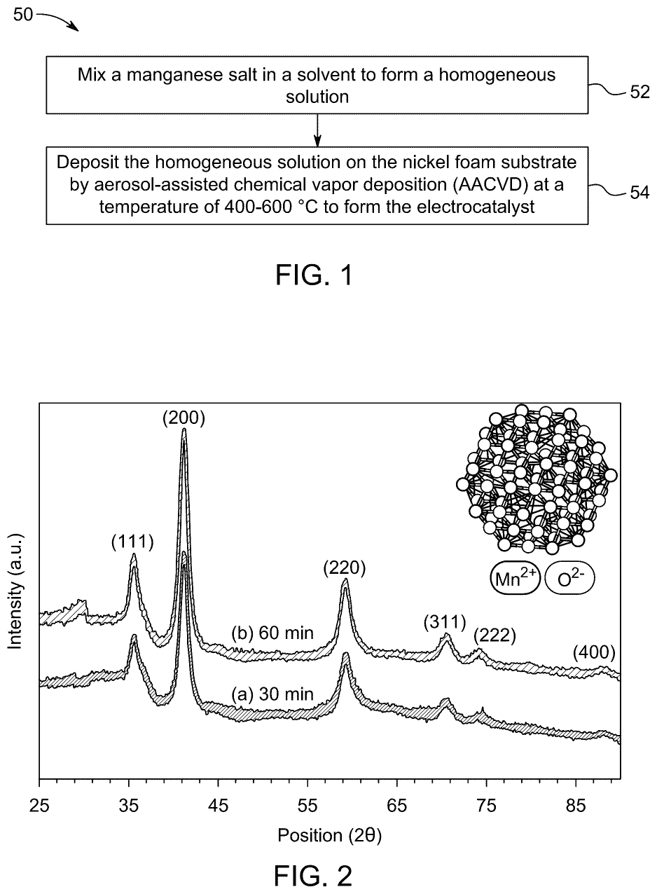

FIG. 1 illustrates a flow chart of a method 50 of preparing the electrocatalyst. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing a manganese salt in a solvent to form a homogeneous solution. Suitable examples of manganese salts include manganese sulfate, manganese chloride, manganese nitrate; manganese nitrate; manganese acetylacetonate, manganese acetate, and mixtures and hydrates thereof. Preferably, manganese salt is manganese(III) acetylacetonate (Mn(C₅H₇O₂)₃). The solvent is at least one selected from the group consisting of a ketone solvent, an ester solvent, an alcohol solvent, an amide solvent, and an ether solvent. In some embodiments, the solvent is the alcohol solvent. In some embodiment, the alcohol solvent is at least one selected from the group consisting of methanol, ethanol, n-propanol, and isopropanol. The mixing may be carried out manually or with the help of a stirrer. It is carried out till the manganese salt is fully dissolved in the solvent, methanol, resulting in a homogenous solution.

At step 54, the method 50 includes depositing the homogeneous solution on the nickel foam substrate by aerosol-assisted chemical vapor deposition (AACVD) at a temperature of 400-600° C. to form the electrocatalyst. The AACVD process involves atomizing the homogenous solution into fine, sub-micrometer-sized aerosol droplets, which are delivered to a heated reaction zone, where the aerosol droplets undergo evaporation, decomposition, and homogeneous and/or heterogeneous chemical reactions to form the desired products. Using the AACVD route, a batch of films with different thicknesses and morphologies can be fabricated in a very short time. This can be achieved by controlling parameters, such as deposition temperature, deposition time, gas carrier flow rate, precursor, and concentration of the precursor solution, to name a few. The aerosolizing process may be performed on an aerosol generator. Many different types of aerosol generators are known and may be used depending on the film desired. In some embodiments, the AACVD is performed at atmospheric pressure. The AACVD process is maintained at a temperature range of 400 to 600° C., preferably 420-580° C., preferably 450 to 550° C., preferably 450° C. At this temperature, the solvent from the aerosol evaporates, leaving behind the precursor. The thickness depends on how long the deposition process takes place. In an embodiment, the deposition process is carried out for a period of 30-60 minutes, preferably 35-55 minutes, or 40-50 minutes to obtain the electrocatalyst.

In an embodiment, a method of generating oxygen is described. The method includes applying a potential of greater than 0 to 2.0 V preferably 0.2 to 1.8 V, 0.4 to 1.6 V, 0.6 to 1.4 V, 0.8 to 1.2 V, or about 1 V, to an electrochemical cell. On applying the potential the aqueous solution is oxidized, thereby forming oxygen. The electrochemical cell includes the electrocatalyst of the present disclosure, and a counter electrode. During the electrochemical process, the electrochemical cell is at least partially submerged preferably 50%, preferably at least 60%, 70%, 80%, 90%, or fully submerged in the aqueous solution.

The electrocatalyst forms the working electrode, while the counter electrode forms the auxiliary electrode. The outer surface of the counter electrode includes an inert, electrically conducting chemical substance, such as platinum, gold, or carbon. The carbon may be in the form of graphite or glassy carbon. Alternatively, the counter electrode may comprise some other electrically-conductive material such as platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. In one embodiment, the counter electrode may be a wire, a rod, a cylinder, a tube, a scroll, a sheet, a piece of foil, a woven mesh, a perforated sheet, or a brush. The counter electrode material should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or lead to undesirable contamination of either electrode.

In one embodiment, the counter electrode is in the form of a rod or wire. The rod or wire may have straight sides and a circular cross-section, similar to a cylinder. A ratio of the length of the rod or wire to its width may be 1,500:1-1:1, preferably 500:1-2:1, more preferably 300:1-3:1, even more preferably 200:1-4:1. The length of the rod or wire maybe 0.5-50 cm, preferably 1-30 cm, more preferably 3-20 cm, and a long wire may be coiled or bent into a shape that allows the entire wire to fit into an electrochemical cell. The diameter of the rod or wire maybe 0.5-20 mm, preferably 0.8-8 mm, more preferably 1-3 mm. In some embodiments, a rod may have an elongated cross-section, similar to a ribbon or strip of metal.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper(II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, a reference electrode is present and is a silver chloride electrode (Ag/AgCl). However, in some embodiments, the electrochemical cell does not include a third electrode.

The aqueous solution includes water and an inorganic base. The base, also referred to as the electrolyte, is selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂) and an alkali metal hydroxide such as lithium hydroxide (LiOH), sodium hydroxide (NaOH), potassium hydroxide (KOH) and rubidium hydroxide (RbOH), and cesium hydroxide (CsOH). In a preferred embodiment, the base is potassium hydroxide. The concentration of the base may lie in a range of about 0.1 molar (M) to 3 M, more preferably 1-2.5 M, and yet more preferably 1.5-2.5 M.

The water may be tap water, distilled water, bidistilled water, deionized water, deionized distilled water, reverse osmosis water, and/or some other water. In one embodiment, the water is bidistilled to eliminate trace metals. Preferably the water is bidistilled, deionized, deionized distilled, or reverse osmosis water and at 25° C. has a conductivity at less than 10 μS·cm⁻¹, preferably less than 1 μS·cm⁻¹, a resistivity greater than 0.1 MΩ·cm, preferably greater than 1 MΩ·cm, more preferably greater than 10 MΩ·cm, a total solid concentration less than 5 mg/kg, preferably less than 1 mg/kg, and a total organic carbon concentration less than 1000 μg/L, preferably less than 200 μg/L, more preferably less than 50 μg/L.

Preferably, to maintain uniform concentrations and/or temperatures of the electrolyte solution, the electrolyte solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably the stirring is done by an impeller or a magnetic stir bar.

In some embodiments, the working electrode and the counter-electrode are connected to each other by way of electrical interconnects that allow for the passage of current between the electrodes, when a potential is applied between them. In a preferred embodiment, the electrocatalyst (which forms the working electrode) and the counter electrode are at least partially submerged in the water and are not in physical contact with each other. In an embodiment, the working electrode and the counter-electrode can have the same or different dimensions.

Preferably, the electrocatalyst functions as the anode, receiving a positive potential to oxidize OH⁻ into O₂ gas and H₂O, while the counter electrode functions as the cathode, receiving a negative potential to reduce water into H₂ gas and OH⁻. This is summarized by the following reactions:

2H₂O₍ₗ₎+2e⁻→H_{2(g)}+2OH⁻_{(aq)} Cathode (reduction)

4OH⁻_{(aq)}→O₂(g)+2H₂O₍ₗ₎+4e⁻ Anode (oxidation)

2H₂O₍ₗ₎→2H_{2(g)}+O_{2(g)} Overall reaction

In another embodiment, the potentials may be switched, wherein the electrocatalyst functions as the cathode and receives a negative potential, and the counter electrode functions as the anode and receives a positive potential. In an alternative embodiment, the electrodes may be subjected to an alternating current (AC) in which the anode and cathode roles are continually switched between the two electrodes.

In one embodiment, the potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor, which is plugged into a standard building or home electric utility line. In one embodiment, the potentiostat may connect with a reference electrode in the electrolyte solution. Preferably the potentiostat is able to supply a relatively stable voltage or potential. For example, in one embodiment, the electrochemical cell is subjected to a voltage that does not vary by more than 5%, preferably by no more than 3%, preferably by no more than 1.5% of an average value throughout the subjecting.

In another embodiment, the voltage may be modulated, such as being increased or decreased linearly, being applied as pulses, or being applied with an alternating current. Preferably, the electrocatalyst may be considered the working electrode, with the counter electrode being considered the auxiliary electrode. However, in some embodiments, the electrocatalyst may be considered the auxiliary electrode with the counter electrode.

In one embodiment, the method further comprises the step of separately collecting H₂-enriched gas and O₂-enriched gas. In one embodiment, the space above each electrode may be confined to a vessel in order to receive or store the evolved gases from one or both electrodes. The collected gas may be further processed, filtered, or compressed. Preferably the H₂-enriched gas is collected above the cathode, and the O₂-enriched gas is collected above the anode. The electrolytic cell, or an attachment, may be shaped so that the headspace above the electrocatalyst is kept separate from the headspace above the reference electrode. In one embodiment, the H₂-enriched gas and the O₂-enriched gas are not 100 vol % H₂ and 100 vol % O₂, respectively. For example, the enriched gases may also comprise N₂ from the air, water vapor, and other dissolved gases from the electrolyte solution. The H₂-enriched gas may also comprise O₂ from the air. The H₂-enriched gas may comprise greater than 20 vol % H₂, preferably greater than 40 vol % H₂, more preferably greater than 60 vol % H₂, and even more preferably greater than 80 vol % H₂, relative to a total volume of the receptacle collecting the evolved H₂ gas. The O₂-enriched gas may include greater than 20 vol % O₂, preferably greater than 40 vol % O₂, more preferably greater than 60 vol % O₂, and even more preferably greater than 80 vol % O₂, relative to a total volume of the receptacle collecting the evolved O₂ gas. In some embodiments, the evolved gases may be bubbled into a vessel comprising water or some other liquid, and higher concentrations of O₂ or H₂ may be collected. In one embodiment, evolved O₂ and H₂, or H₂-enriched gas and O₂-enriched gas, may be collected in the same vessel.

Several parameters for the method for decomposing water may be modified to lead to different reaction rates, yields, and other outcomes. These parameters include but are not limited to, electrolyte type and concentration, pH, pressure, solution temperature, current, voltage, stirring rate, electrode surface area, size of manganese oxide particles, porosity, and exposure time. A variable DC current may be applied at a fixed voltage, or a fixed DC current may be applied at a variable voltage. In some instances, AC current or pulsed current may be used. A person having ordinary skill in the art may be able to adjust these and other parameters, to achieve different desired nanostructures. In other embodiments, the electrochemical cell may be used for other electrochemical reactions or analyses.

The electrocatalyst has an overpotential of 140-160 millivolts (mV), preferably 145-155 mV, or about 150 mV for a current density of 10 milliamperes per square centimeter (mA cm⁻²). Also, the overpotential does not vary by more than 5%, preferably 4%, 3%, 2%, or 1% after the potential is applied for 2-50 hours, indicating the long-term stability of the electrocatalyst. Overpotential in electrolysis refers to the extra energy required than thermodynamically expected to drive a reaction. To make the process commercially viable, a low overpotential is required.

The electrocatalyst of the present disclosure has a current density of at least 1000 mA/cm², when the electrodes are subjected to a potential of 430 mV; and an electrochemical surface area of 120-160 cm², preferably 130-150 cm² or about 140 cm². One of the indicators that assess the OER kinetics is the Tafel slope. The Tafel slope shows how efficiently an electrode can produce current in response to a change in applied potential. Therefore, a low Tafel slope indicates that less overpotential is required to get a high current. The electrode has a Tafel slope of 80-110 mV/decade, which is lower than the bare substrate (212.81 mV/decade), indicating that the electrode of the present disclosure facilitates the energy-intensive step during the OER process.

While not wishing to be bound to a single theory, it is thought that the unique cauliflower high coverage structure made by the AACVD synthesis method improves catalytic activity. Also, the penetration of the particles into the micropores of the nickel foam substrate provides more catalytic active sites and abundant electron pathways that can improve the contact area between electrolyte and electrode material.

In an alternative embodiment, the electrocatalyst of the present disclosure may be used in the field of batteries, fuel cells, photochemical cells, water splitting cells, electronics, water purification, hydrogen sensors, semiconductors (such as field effect transistors), magnetic semiconductors, capacitors, data storage devices, biosensors (such as redox protein sensors), photovoltaics, liquid crystal screens, plasma screens, touch screens, OLEDs, antistatic deposits, optical coatings, reflective coverings, anti-reflection coatings, and/or reaction catalysis.

### EXAMPLES

The following examples demonstrate a method of generating oxygen using an electrocatalyst as described herein. The examples are provided solely for illustration and are not to be construed as limitations of the present disclosure, as many variations thereof are possible without departing from the spirit and scope of the present disclosure.

### Example 1: Reagents and Materials

All the chemicals, solvents, or reagents used in this research were of the highest purity. The precursors for MnO electrocatalyst fabrication, manganese (III) acetylacetonate and methanol, were of analytical quality. They were purchased from Sigma-Aldrich and used as received without further purification. The nickel foam or NF (93% porosity) used as substrate material was purchased from the Goodfellow company.

### Example 2: Fabrication of Manganese Oxide on Nickel Foam (MnO@NF)

Manganese (II) oxide (MnO) thin films were produced using the aerosol-assisted chemical vapor deposition (AACVD) process. For this purpose, manganese (III) acetylacetonate (Mn(C₅H₇O₂)₃), abbreviated as Mn(acac)₃), was used as a precursor. The schematic design and operation of the custom-made AACVD setup is previously reported [Ehsan, M. A.; Rehman, A.; Afzal, A.; Ali, A.; Hakeem, A. S.; Akbar, U. A.; Iqbal, N., Highly Effective Electrochemical Water Oxidation by Millerite-Phased Nickel Sulfide Nanoflakes Fabricated on Ni Foam by Aerosol-Assisted Chemical Vapor Deposition. Energy & Fuels 2021, 35 (19), 16054-16064; and Rehman, A.; Ehsan, M. A.; Afzal, A.; Ali, A.; Iqbal, N., Aerosol-assisted nanostructuring of nickel/cobalt oxide thin films for viable electrochemical hydrazine sensing. Analyst 2021, 146 (10), 3317-3327, both incorporated herein by reference in their entirety]. Film deposition was conducted on a nickel foam substrate at a temperature of 450° C. The deposition time was varied from 30 to 60 minutes under the nitrogen flow (99.99% purity) as an inert carrier gas until the complete MnO film deposition was attained with the nickel foam substrate.

Mn(acac)₃ (100 mg, mmol) was generally dissolved in 15 mL of methanol solvent. The dark brown clear solution was ultrasonically transformed into aerosol mist sprayed over the pre-heated nickel foam substrate (2 cm×1 cm) at 450° C., staying inside the horizontal tube furnace of the AACVD setup. The AACVD process was repeated for 30 and 60 minutes, respectively, and two MnO film samples were obtained, namely MnO@NF-30 and MnO@NF-60. The MnO-deposited films appeared dark brown and had good adhesion with the rough surface of nickel foam. The AACVD deposition process was repeated several times to ensure the reproducibility of the MnO-fabricated films. The deposition process required only Mn(acac)₃ precursor and methanol as reagents.

### Example 3: Structural Characterization Techniques

The X-ray diffraction (XRD) analysis of MnO@ NF films was performed on a benchtop Rigaku MiniFlex X-ray diffractometer (manufactured by Rigaku, 3 Chome-9-12 Matsubaracho, Akishima, Tokyo 196-8666, Japan) using Cu Kα1 radiation (α=0.15416 nm). The operational procedure of XRD was carried out by maintaining a tube current of 10 mA and an accelerating voltage of 30 kV. A field-emission scanning electron microscope (FESEM) investigated the surface morphology of MnO@ NF films, and their microstructure was analyzed by FESEM (Tescan Lyra3, 21 Libus̆ina T, Brno—Kohoutovice, 623 00, Czech Republic) operated at an accelerating voltage of 20 kV. The elemental composition of MnO@ NF films was determined by energy-dispersive X-ray spectroscopy ((EDX, INCA Energy 200, Oxford Instruments, Tubney Woods, Abingdon, Oxon, OX13 5QX, U.K). The high-resolution thin film nanostructure of MnO@NF was studied by transmission electron microscope (HR-TEM) from JEOL-JEM2100F, Japan, run at an accelerating voltage of 200 kV. Finally, the quantitative information and chemical states of each element in the MnO@ NF film were achieved by X-ray photoelectron spectroscopy (XPS). For XPS characterization, XPS-ESCA analytical Services were availed from MSE Supplies, 3440 E Britannia Dr #190, Tucson, AZ 85706, United States.

### Example 4: Electrochemical Measurement Techniques

The electrocatalytic measurements were carried out using an automated Gamry INTERFACE 1010 E potentiostat facilitated with a typical three-electrode electrolytic glass cell. The MnO@NF films deposited on Ni foams were applied as working electrodes, while Ag/AgCl/3M KCl and Pt wire were used as the reference and counter electrodes, respectively. The electrocatalytic studies were made in a 1 M potassium hydroxide (KOH) of pH=14 electrolyte solution. Entire electrochemical measurements were performed at room temperature. All the electrochemical measurements, like cyclic voltammetry (CV), Linear Sweep Voltammetry (LSV), Impendence spectroscopy (EIS), and chronopotentiometry (CP), are performed at standard electrode potential. All the current density values were normalized by the geometrical area (1 cm²) of the NF electrodes. Where necessary, the electrochemical data, such as potential, is converted to RHE using the standard conversions.

$${E}_{( RHE )} = {E}_{( ref )} + 0.05 \; 91 \times pH + 0.197 \qquad ( 1 )$$

Here, E_{ref} is the potential recorded against the reference electrode.

### Example 5: Structural Characterization

FIG. 2 illustrates the XRD pattern of manganese oxide films deposited on a non-crystalline glass substrate for 30 and 60 minutes, represented as MnO@NF-30 and MnO@NF-60, respectively. As the NF exhibited high crystallinity and suppressed the peaks from deposited samples, films on a non-crystalline glass substrate were deposited to elucidate the true crystalline structure of the fabricated MnO samples. The intensity and sharpness of the diffraction peaks indicated that both samples possess a high degree of crystallinity. Six defined diffraction peaks were detected at 2θ values of 35°, 40.8°, 59°, 70.5°, 74.2° and 88.3°. They corresponded to (111), (200), (220), (311), (222), and (400) indices of cubic MnO structure bearing a space group Fm3⁻m according to ICSD 29326). The diffraction peaks of MnO@NF-30 electrocatalyst were entirely superimposed over MnO@NF-60 electrocatalyst, which elucidates the formation of similar crystalline phases in both MnO films. It further disclosed that change in deposition time did not pose any influence on the MnO crystallinity. Literature showed that in the cubic crystal structure of MnO, Mn²⁺ is attached to six comparable O²⁻ atoms representing a combination of corner and edge-sharing MnO₆ octahedra. All Mn—O bond lengths are 2.22 Å. In addition, O²⁻ is bonded to six equivalent Mn²⁺ atoms to form a mixture of corner and edge-sharing OMn₆ octahedra. XRD analysis likewise makes it obvious that no diffraction planes for other manganese oxide phases, including Mn₂O₃ or Mn₃O₄, were detected. This validates the conversion of Mn(acac)₃ of the entire precursor to MnO during the AACVD process at 450° C. for 30-60 minutes. Hence, no other peaks were observed. As a result, the XRD study illustrates the high purity of the single-phase MnO electrocatalyst.

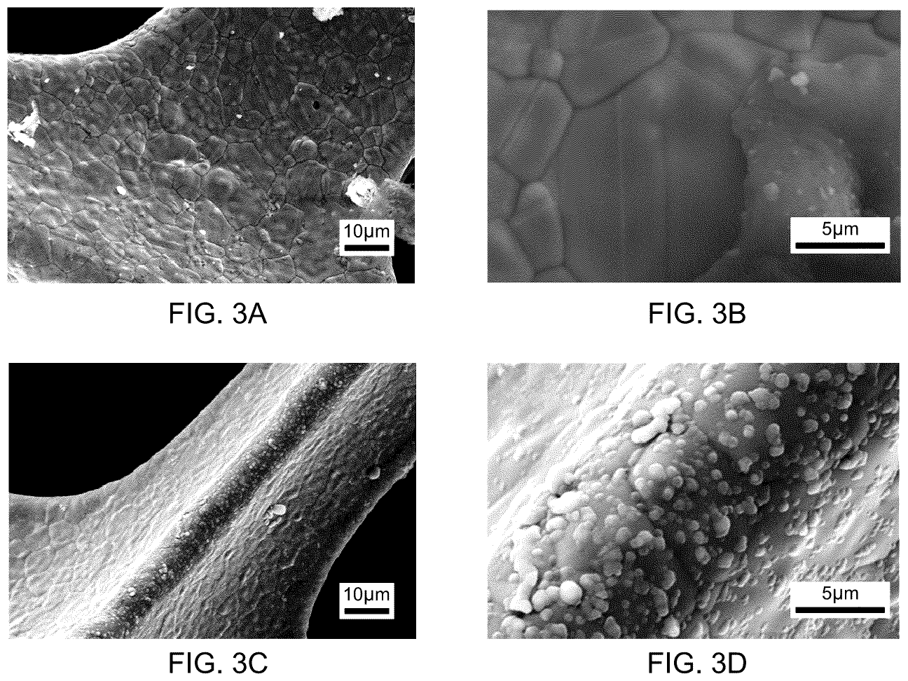

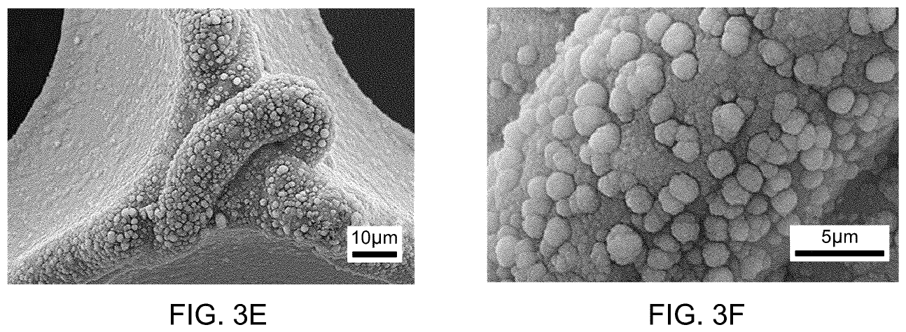

FIG. 3 depicts the FE-SEM micrographs of bare-NF, and MnO deposited over NF via AACVD at 450° C. with variable reaction times of 30 and 60 minutes, respectively. FIG. 3A and FIG. 3B specifies bare NF skeletons containing smooth and flat surfaces. The presence of some superficial tiny pores on the NF skeleton demonstrates the porous structure of NF. The porous structure provides abundant electron pathways that can improve the contact area between electrolyte and electrode material and are advantageous for better electrocatalytic properties. Once the AACVD deposition of MnO has been accomplished, the tiny pores disappear. The surface of NF was inhabited by nanoscale MnO structures, as depicted in the corresponding FIG. 3C and FIG. 3D. FIG. 3C exhibits an SEM micrograph of MnO fabricated on NF after 30 minutes of the AACVD process. The growth of nanoscale particles on the surface of NF was observed. However, the corresponding high-resolution SEM micrograph, as observed in FIG. 3D, demonstrates that the surface of NF was not completely contained with MnO particles, implying that 30 min deposition time was insufficient to develop a complete film layer. Accordingly, the AACVD process was extended for a total of 60 minutes. The NF surface acquired hereafter, as seen in FIG. 3E was densely packed with MnO uneven morphology, which resembles cauliflower-like objects, extensively grown on the NF surface, as manifested in FIG. 3F.

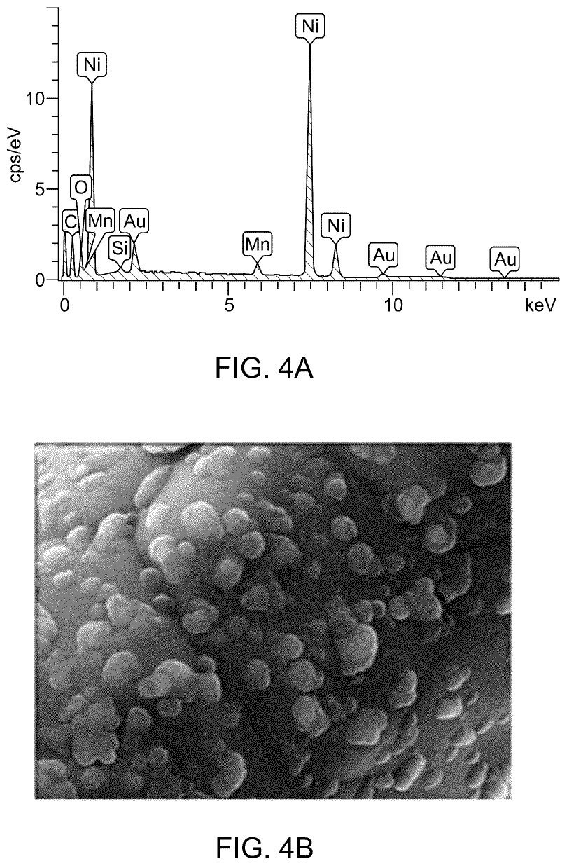

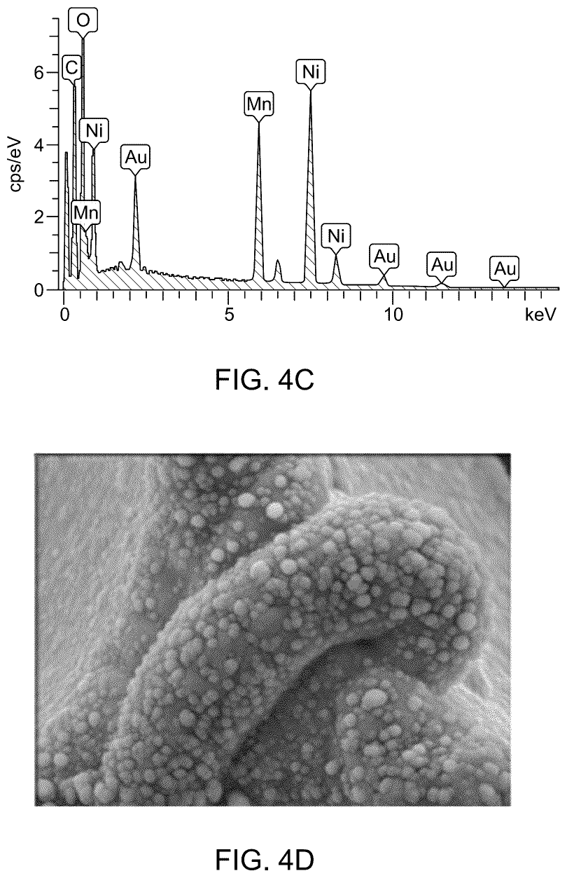

To investigate the elemental composition of each MnO film deposited on the NF, EDX analysis was performed. The corresponding EDX spectra are presented in FIGS. 4A and 4B for the MnO@NF-30 catalyst; and FIGS. 4C and 4D for the MnO@NF-60 catalyst, which exhibited the manifestation of Mn, Ni, O, and Au elements in their substantial amounts and ratios. The Mn and O represented the formation of MnO, whereas Ni elemental peak emerged from the NF substrate. The presence of Au was also obvious as the MnO@ NF films were sputter coated with gold, a well-recognized FE-SEM procedure that helps to reduce the charging effect for samples under FE-SEM observation; therefore, Au has also appeared.

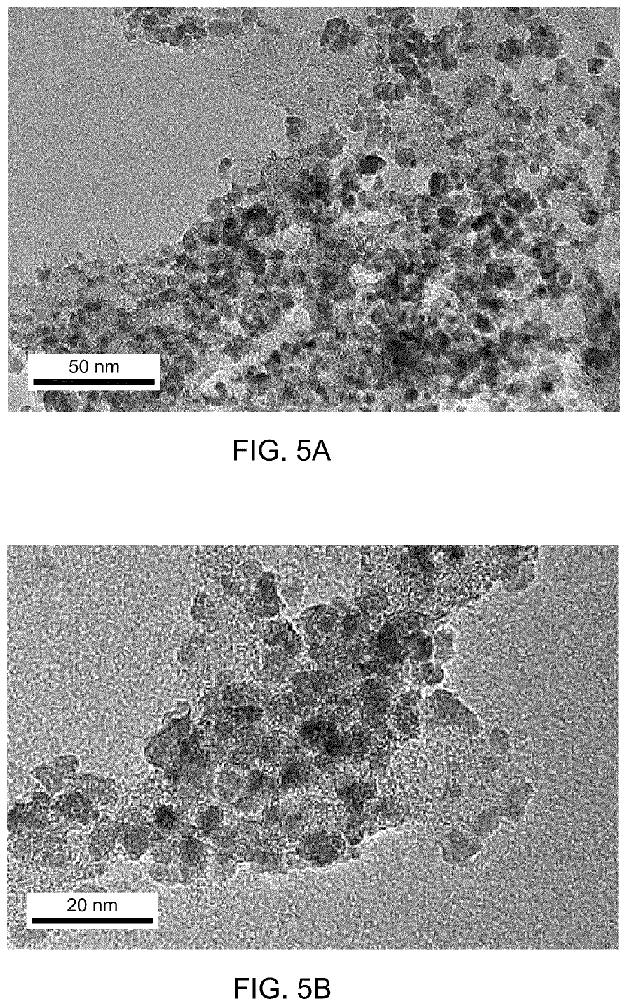

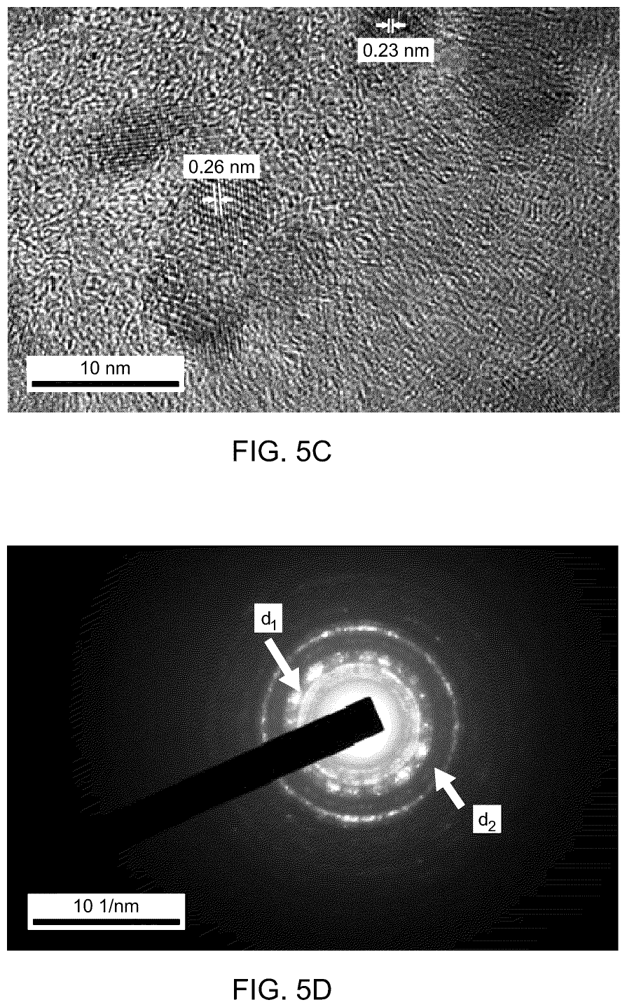

High-resolution transmission electron microscopy (HR-TEM) was performed to investigate the structure-property relationship and determine the crystallinity of the MnO films fabricated by AACVD. As FE-SEM studies demonstrated incomplete growth of MnO on NF for 30 minutes, HR-TEM studies were only performed for MnO@ NF for 60 minutes. FIG. 5A represents the TEM images of MnO film grown for 60 minutes. Typical TEM micrographs FIG. 5A and FIG. 5B revealed a large number of aggregated spherical morphology, which is coherent with those observed by FE-SEM. The HR-TEM micrographs of the individual MnO cauliflower-like sphere (FIG. 5C) are consistent with (111) and (200) planes of MnO, which correspond to the cubic structure. In addition, the typical diffraction rings in the selected area electron diffraction (SAED) pattern (FIG. 5D) demonstrate the polycrystalline nature of the MnO, while di and d₂ correspond to the (111) and (200) hkl reflection planes, respectively.

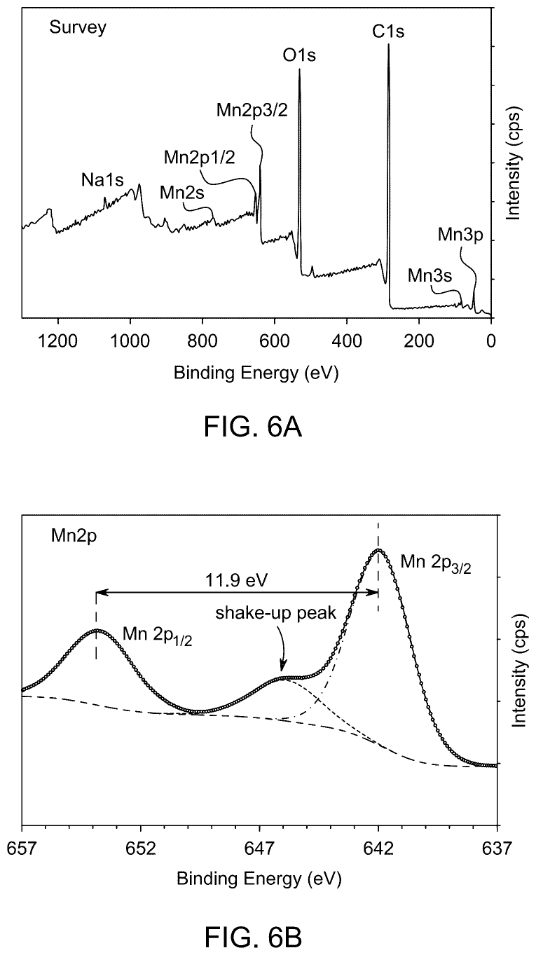

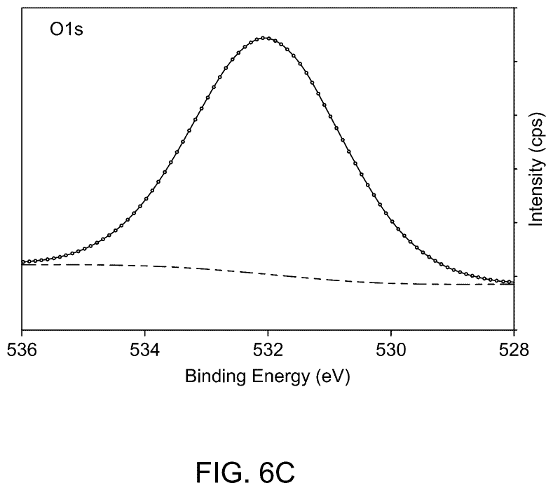

X-ray photoelectron spectroscopy (XPS) of metallic compounds shows the chemical states and their oxidation states. This is because transition metals could form variable oxidation state materials during fabrication. For example, manganese, upon interaction with oxygen, can also form various oxides with Mn in different oxidation states (Mn²⁺ or Mn⁴⁺). Herein, the XPS study of MnO films by AACVD fabrication and corresponding Mn chemical states have been identified and presented in FIG. 6B.

From the XPS results, the dissociative adsorption of oxygen during AACVD and the formation of MnO as the initial phase seems well established. XPS was used to analyze the elemental and electronic surface states of MnO fabricated by AACVD at 60 minutes. The survey XPS spectrum (FIG. 6A) unveils the predominant presence of Mn, O, and C elements. An in-depth analysis of the Mn 2p spectrum (FIG. 6B) reveals the emergence of peaks at 642 and 653.9 eV, corresponding to Mn 2p_{3/2} and Mn 2p_{1/2}, respectively. The spin-orbit splitting between Mn 2p_{3/2} and Mn 2p_{1/2} is 11.9 eV, confirming the existence and crystallization of the MnO electrocatalyst. The shake-up peak that appeared at 646 eV is the characteristic photoelectron peak of MnO. Furthermore, the binding energy peak at 530.75 eV, shown in FIG. 6C indicates that O is present in the O²⁻ state, and bonds with Mn atoms.

### Example 6: Electrochemical Characterization

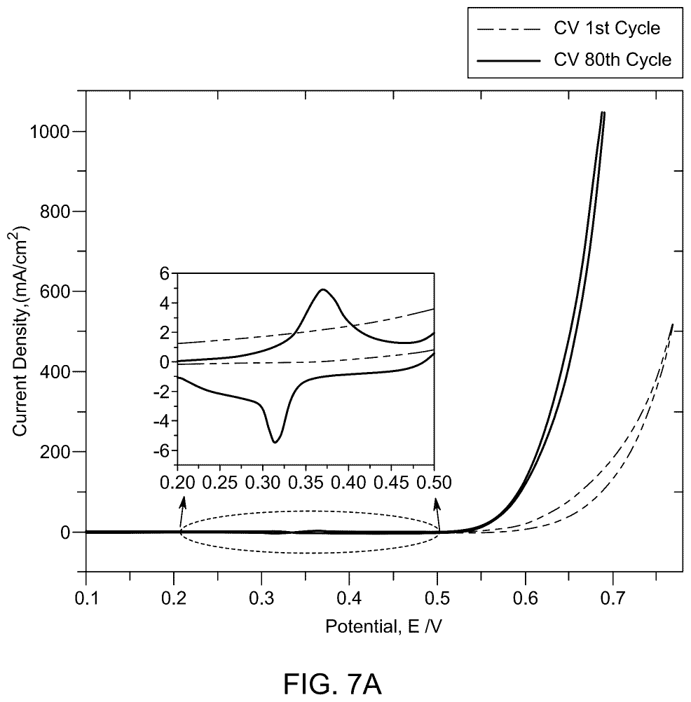

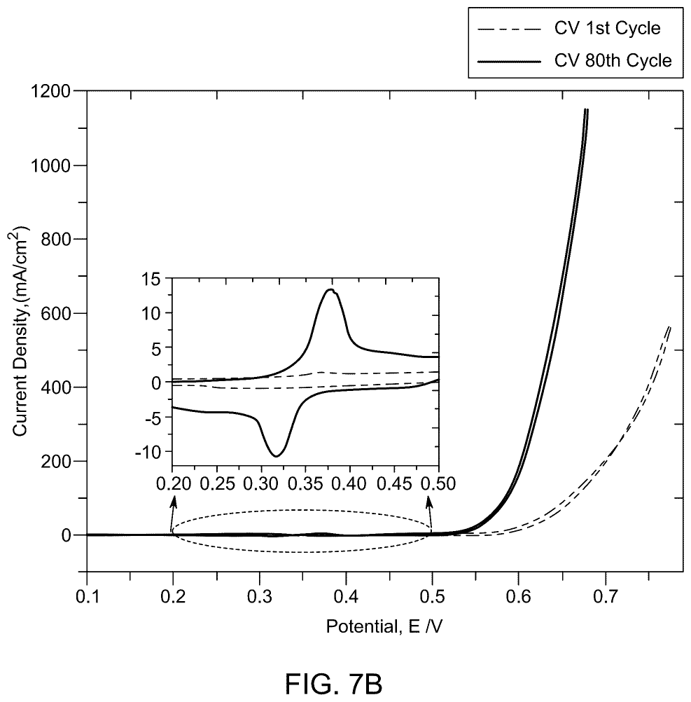

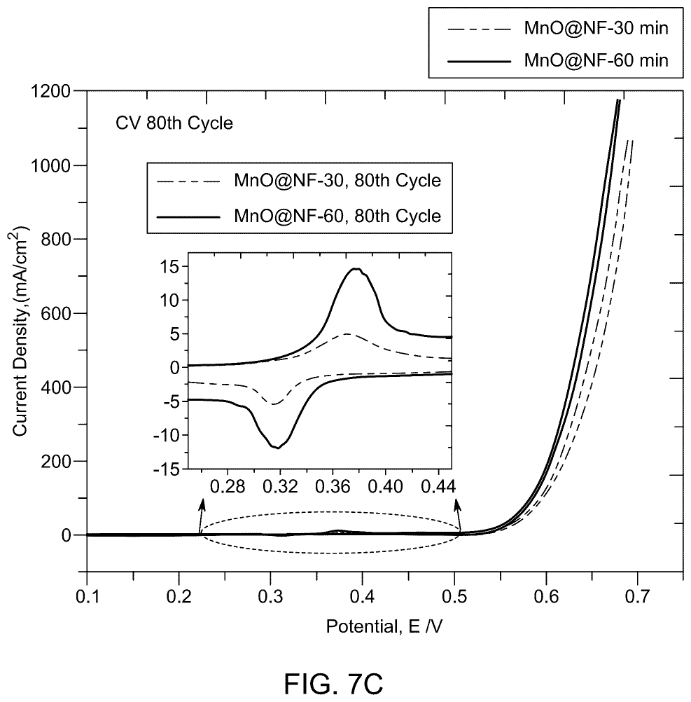

Cyclic voltammetry (CV) was used to evaluate the electrochemical attributes of MnO@NF-30 and MnO@NF-60. From CV analysis, an insight into superficial electron transfer reactions taking place at the catalyst surface is determined. In addition, CV helps to estimate the reaction kinetics and durability of the electrocatalyst over the applied potential range under specific electrochemical conditions. The consecutive CV scans activate the surface-active sites of the catalyst and boost the water oxidation performance of the catalytic MnO@NF films. FIGS. 7A-C depict the CV scans conducted at a 50 mV/sec scan rate in 1.0 M KOH electrolyte for both MnO@NF-30 and MnO@NF-60 catalysts for performing OER. FIG. 7A and FIG. 7B compares the 1^{st}, and the 80^{th} CV cycles of MnO prepared for 30 and 60 minutes, respectively. In both cases, the oxidation peak appears around 0.4 V with forward bias, while reduction occurs around 0.3 V on the reverse bias. Another observation is the intensity of the redox peak and its area, which increases with every CV cycle. The corresponding 80^{th} CV cycle is larger than the 1^{st} CV cycle (Inset of FIG. 7A and FIG. 7B).

During the redox reaction, the oxidation peaks are recognized due to the in-situ formation of higher oxidation spices, i.e., Mn (II) to Mn (V) oxides. These are known as catalytic active species and are responsible for cleaving hydroxyl ion (O—H) at higher rates, boosting the kinetics of oxygen evolution reaction. While FIG. 7C equates only the final CV (80^{th} cycle) for MnO@NF-30 and MnO@NF-60 electrocatalysts, the inset of FIG. 7C depicts that the redox peak of MnO@NF-60 catalyst is much larger than the MnO@NF-30, indicating that the amount of active species formed in the case of 60 min is greater than that of the 30 min variant. Consequently, MnO@NF-60 showed improved OER process and high current density at lower potentials during the electrochemical investigations.

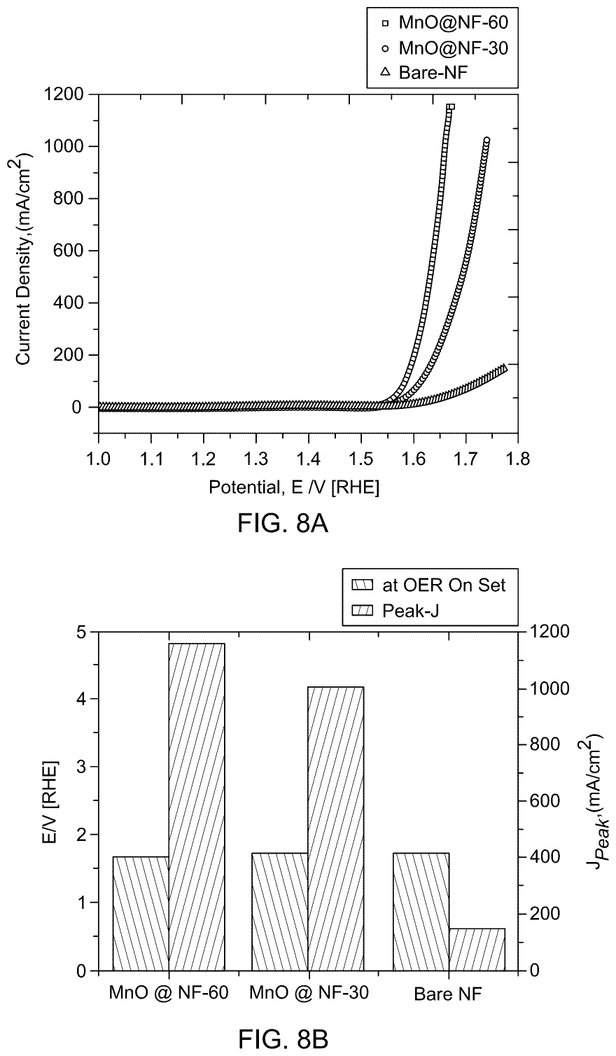

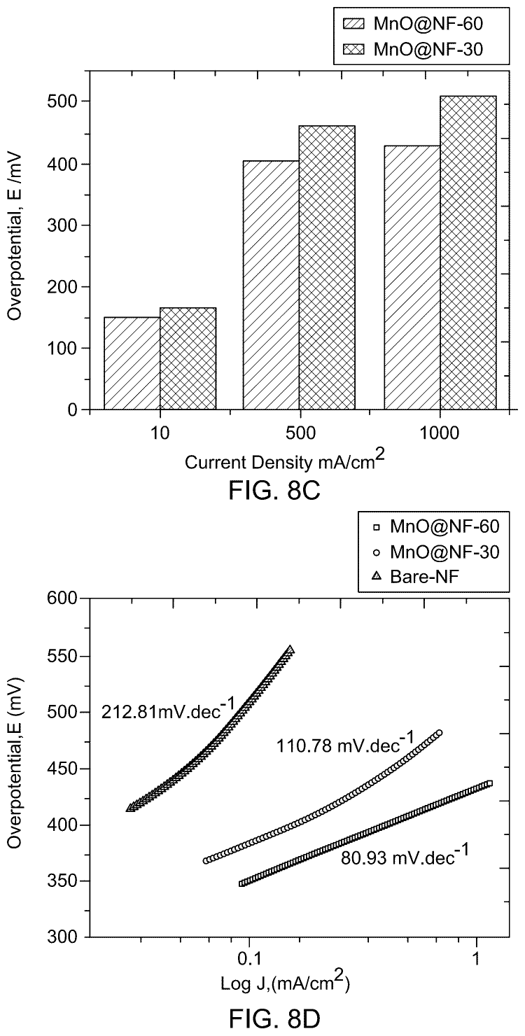

Further OER characteristics were investigated by linear sweep voltammetry (LSV). FIG. 8A shows the LSV curves performed at a scan rate of 2 mV/s for both MnO, as well as bare NF electrodes in 1.0 M KOH electrolyte solution. The LSV current density (J) vs. E profiles exhibited superior OER activity, i.e., J≥1158 mA/cm² at E (RHE)=1.67 V by MnO@NF electrocatalyst prepared at 60 minutes by AACVD. MnO@NF-60 revealed comparatively better OER activity as observed from MnO@NF-30 (J≥1000 mA/cm² at E (RHE)=1.73 V), and bare@NF (J=136 mA/cm² at E (RHE)=1.75 V) electrodes respectively as described in FIG. 8A and FIG. 8B. The OER activity of the MnO@NF-60 electrode commenced even at a lower potential, i.e., 1.45 V (vs. RHE). As sweeping the potential beyond the positive range, a quick rise in catalytic current was observed, attaining a peak maximum current density of ≥1158 mA/cm² at an overpotential of 430 mV.

FIG. 8C depicts the efficiency of the electrocatalytic activity of MnO films fabricated by the AACVD method at different periods. A semiconducting energy conversion device is considered effective and sustainable if the benchmark 10 mA/cm² current density is achieved at or below 350 mV of overpotential. This decade current has been achieved by the MnO@NF-60 catalyst, as presented in FIG. 8C, at a low overpotential of 150 mV, and MnO@NF-30, showed a decade current at an overpotential of ≥160 mV.

A Tafel plot [overpotential vs. log (current density)] is another standard parameter to evaluate the electrocatalytic OER performance. A Tafel plot and subsequent Tafel slope can be estimated from the LSV polarization curves in such a way that its linear part is extrapolated. Following the equation below, a Tafel slope can be acquired.

$$η = b Log j + a \qquad ( 2 )$$

Where η is overpotential, b is the Tafel slope, and a is constant.

FIG. 8D signifies that MnO@NF-60 possesses the lowest Tafel slope of 80.93 mV/dec compared to 110.78 mV/dec for MnO@NF-30 and 212.81 mV/dec corresponding to bare NF, respectively. A lower Tafel slope represents the predominant production of surface-adsorbed species in the early stage of the OER reaction.

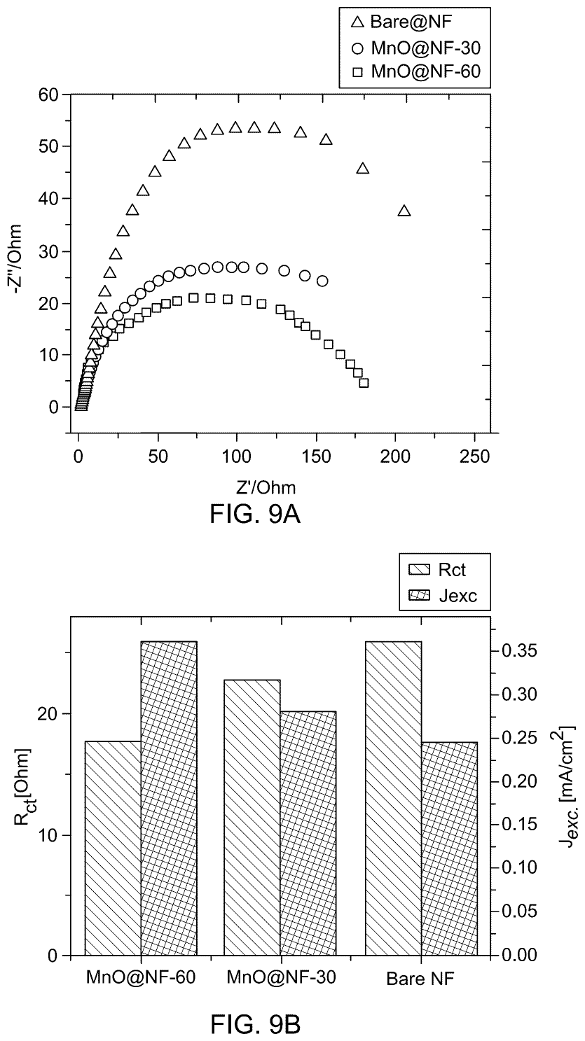

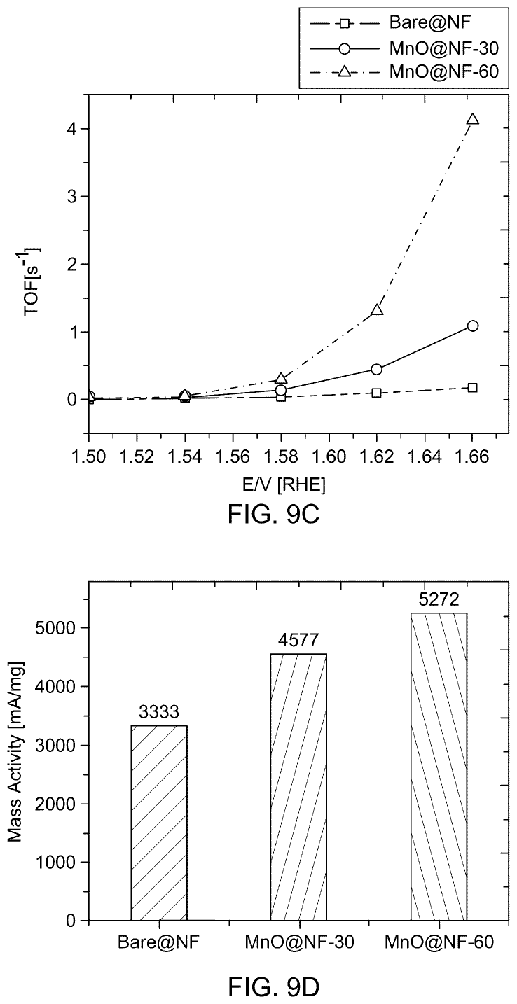

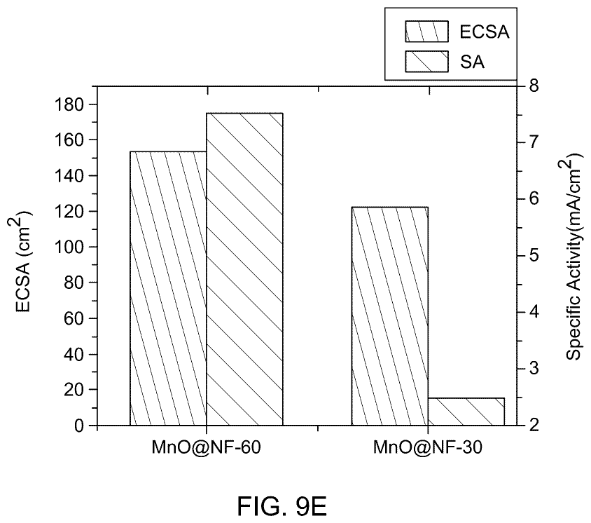

Impedance analysis was accomplished to appraise the OER activity and interfacial behavior of the MnO@NF electrocatalysts prepared by AACVD. The EIS data and subsequent Nyquist plots are demonstrated in FIG. 9. It is evident from FIG. 9A that the EIS arc size of MnO@NF-60 is smaller than that of MnO@NF-30 and bare NF films, which indicates the higher conductivity of the MnO catalyst prepared for 60 min. The charge transfer resistance (R_{CT}) estimated by MnO@NF-60, MnO@NF-30, and bare NF films are 17.7Ω, 22.8Ω, and 26Ω, respectively. Therefore, there are limited interfacial charge transfer barriers and low charge transfer resistance but enhanced electron transfer reactions at the surface of MnO@NF films prepared by AACVD.

FIG. 8B presents the comparison of charge transfer resistance (R_{CT}) and exchange current density (j_{exc} (mA/cm²). Exchange current density (J_{exc}) is another factor to evaluate the inherent electrochemical activity of the MnO electrocatalysts. The exchange current density of MnO@NF-60, MnO@NF-30, and bare@NF electrocatalysts is calculated considering charge transfer resistance at the electrode-electrocatalyst/electrolyte interface using the following relation.

$$Exchange Current Density ( {J}_{exc} ) = RT / nAF θ \qquad ( 3 )$$

Where R stands for the ideal gas constant (R=8.314 J/K·mol), T is room temperature in kelvin (298 K), n is designated as the number of electrons (n=4) in a typical OER, F represents the Faraday constant (F=96485 C/mol), A elaborates charge transfer resistance (kg·m²·s³·A⁻²), and θ is the physical area (θ=1 cm²) of working electrodes. FIG. 9B shows a bar graph of J_{exc} vs. R_{CT}, and, MnO@NF-60 shows a high J_{exc} of 3.6×10⁻⁴ mA/cm², unlike J_{exc} of MnO@NF-30 and bare NF are found to be 2.81×10⁻⁴ mA/cm² and 2.46×10⁻⁴ mA/cm², respectively. This elucidates better electron transfer was observed by MnO electrocatalyst fabricated by AACVD at 60 minutes with respect to such interactions seen in MnO@NF-30 and bare NF electrodes in 1 M KOH electrolyte.

FIG. 9C illustrates the turnover frequency (TOF) for MnO @NF catalysts to evaluate their electrocatalytic OER efficiency. TOF for MnO@NF-60, MnO@NF-30, and bare@NF was estimated by employing a standard equation at various potentials directly examined from the LSV polarization curves. TOF is determined utilizing the following mathematical correlation.

$$Turn over Frequency ( TOF ) = j \times A / 4 \times F \times m \qquad ( 4 )$$

Where j stands for current density (A/m²) achieved at different overpotentials, A is the geometrical surface area of NF substrate (A=1 cm²), and F is the Faraday constant (96,485 C mol⁻¹), and m is the amount of MnO moles of electrocatalyst accumulated on top of NF substrate. The mass of MnO catalysts deposited by the AACVD was found to be 0.11, 0.22, and 0.22 mg for MnO@NF-60, MnO@NF-30, and bare@NF, respectively. The TOFs calculated for MnO@NF-60, MnO@NF-30, and bare@NF are 4.51 s⁻¹, 1.12 s⁻¹, and 0.16 s⁻¹, which depicts MnO@NF prepared at 60 minutes by AACVD has offered ample active sites for substantial electron transfer reaction in the alkaline electrolyte.

FIG. 9D accounts for the mass activity of the MnO electrocatalysts. The mass activity of MnO OER electrocatalysts is calculated by normalizing the current density with the loaded mass of the catalyst on NF. It is well recognized that overpotential was considered where the MnO catalyst offered the highest current density. Furthermore, it is also presumed that all MnO@NF-60 sites were catalytically active before estimating mass activity, such as by performing repeated CV. The mass activity was calculated using the following equation:

$$Mass Activity ( MA ) = {J}_{η @ 430} / mass of catalyst \qquad ( 5 )$$

It is observed that MnO@NF-60 exhibits a high mass activity of 5272 mA/mg relative to MnO@NF-30 and bare NF, which shows mass activity values of 4577 mA/mg and 3333 mA/mg determined at 430 mV overpotential.

FIG. 9E portrays a comparative analysis of electrochemically active surface area vs. specific activity of the MnO electrocatalyst. The specific activity is another intrinsic activity of an electrocatalyst that elaborates its electrocatalytic properties upon various mass loadings of the catalysts. The specific activity (Jₛ) of MnO electrodes fabricated over NF was calculated using the following equation:

$$Specific Activity ( {J}_{s} ) = J {η}_{@ 430} / RF \qquad ( 6 )$$

Where J_{η} is the current density recorded at a certain overpotential, and RF is the roughness factor of electrodes. RF is the ratio of ECSA divided by the physical or geometrical area of the electrodes. The relation of RF calculation is described below.

$$Roughness Factor ( RF ) = ECSA / {A}_{geo} . \qquad ( 7 )$$

Where ECSA is the electrochemical surface area and A_{geo}, is the electrodes' physical area, which is 1 cm² in current studies. FIG. 9E shows that the specific activity of electrocatalyst MnO@NF prepared at 60 minutes was much more pronounced than its counterpart MnO@NF fabricated at a 30-minute time period.

CV analysis in the non-faradic regions is useful to compute the electrochemical surface area (ECSA) of the electrocatalysts. The ECSA can be deduced in electrochemical reactions by calculating the Helmholtz double-layer capacitance (DLC). The ECSA assesses the activity of the electrocatalyst because the current measured with sweeping potential is proportional to the electrode's area exposed to the electrolyte solution. There are two strategies to estimate DLC: differential capacitance measurement (DCM) and impedance spectroscopy (EIS) analysis. The ECSA is calculated using this expression:

$$Electrochemical Surface Area ( ECSA ) = {C}_{DL} / {C}_{s} \qquad ( 8 )$$

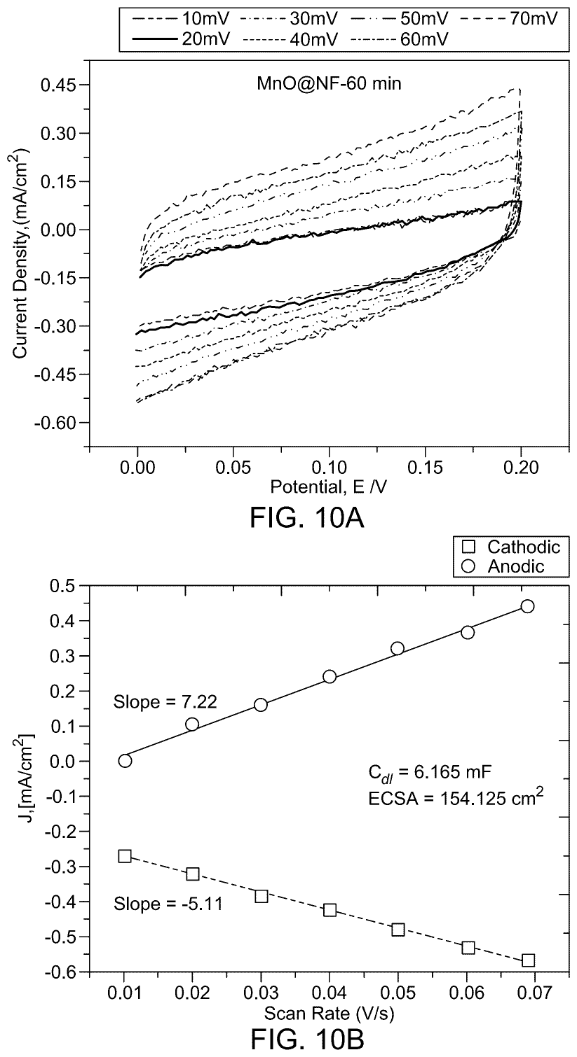

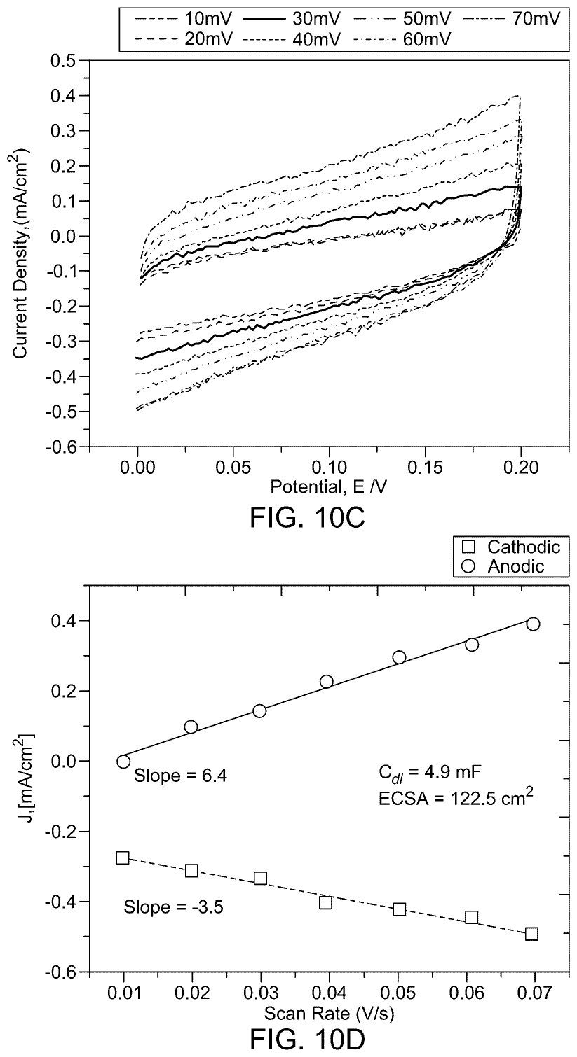

In equation 8, the second value required for estimating the ECSA is specific capacitance (Cₛ), which is the capacitance for a fully smooth surface of the catalyst material. For metallic electrodes in an alkaline solution, Cₛ is 0.04 cm². CV analysis for ECSA performs a differential capacitance measurement (DCM) with different scan rates in a limited potential scale. If this measurement lies in the range of the non-faradaic region where no faradic reaction is observed, then the resulting differential capacitance is called the double-layer capacitance. Likewise, the double-layer capacitance for MnO@ NF-30 and MnO@ NF-60 was revealed after measuring the CV curves for respective electrode materials in the non-faradaic regions at 10 mV/s to 70 mV/s scan rates as of FIG. 10A and FIG. 10C. The current density (j) increased linearly with the scan rate, and the electrical double-layer capacitance was determined by averaging the cathodic and anodic slopes of the plots of current versus scan rate, as displayed in FIG. 10B and FIG. 10D. From these measurements, the double-layer capacitance, and corresponding ECSAs were estimated. For example, MnO@NF-60 fabricated by AACVD showed a higher ECSA of 154.125 cm² compared to MnO@NF-30 which is 122.5 cm².

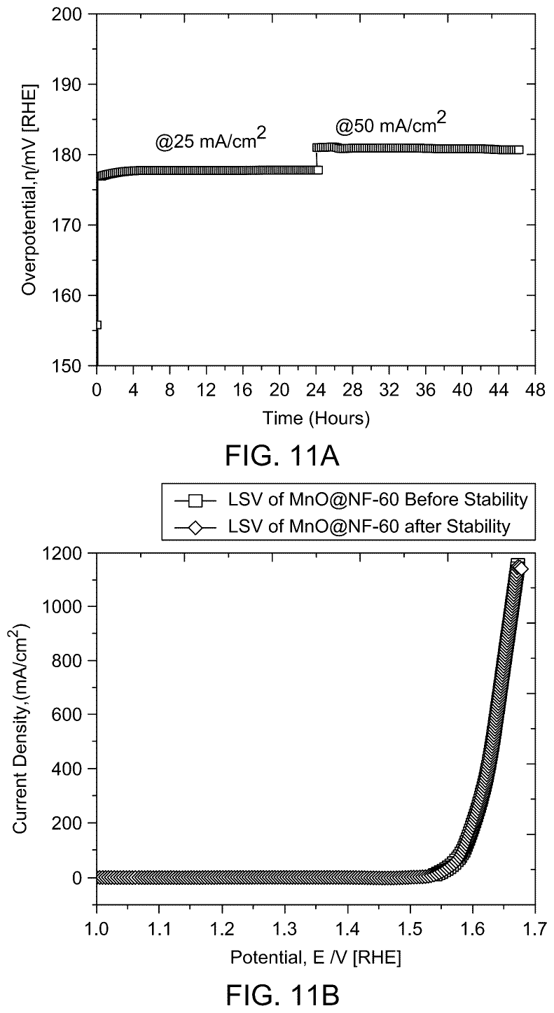

To determine the stability of the electrocatalysts, chronopotentiometry studies were performed at two different current densities, 25 and 50 mA/cm², respectively, for 48 hours. FIG. 11A presents the subsequent time versus overpotential graph displaying the stability profile of MnO@NF-60. The stable linear overpotential response against two applied current densities reinforces the extended stability of the MnO@NF-60 catalyst during the long-term electrocatalytic water oxidation process. A stable overpotential of 177.5 mV at applied current density (η₂₅) of 25 mA/cm² was attained until the first 24 hours. A small increase in overpotential was initially observed for the first 2 hours. Here the overpotential started to rise from 176.5 mV at η₂₅, followed by a stable plateau of 177.5 mV, and afterward remained consistent for the rest of the time till 24 hours. As the current density was increased to 50 mA/cm², a consistent overpotential response of 188 mV was recorded for the next 24 hours of the measurement. These findings showed that the MnO@NF-60 prepared at 60 minutes by the AACVD method showed stable overpotentials at two different applied current densities and showed the catalyst's durability in the alkaline solution for 48 hours.

To further examine the stability of the MnO@NF-60 electrocatalyst, soon after the durability measurements, LSV polarization studies were performed. FIG. 11B reports the comparative analysis of LSV curves obtained immediately and compares its response with LSV curves recorded before stability analysis for the MnO@NF-60 electrode. Both LSV polarization curves after the stability analysis and before showed consistent behavior throughout the sweeping potential window tested. Hence, it reinforces that MnO@NF prepared at 60 minutes of fabrication time showed long-term stability, alike LSV profiles recorded before and after the stability measurements.

Numerous modifications and variations of the present disclosure are possible in light of the above teachings. It is therefore to be understood that within the scope of the appended claims, the invention may be practiced otherwise than as specifically described herein

1: A method of generating oxygen, comprising:
applying a potential of greater than 0 to 2.0 V to an electrochemical cell,
wherein the electrochemical cell is at least partially submerged in an aqueous solution,
wherein on applying the potential the aqueous solution is oxidized thereby forming oxygen,
wherein the electrochemical cell comprises:
an electrocatalyst; and
a counter electrode;
wherein the electrocatalyst comprises:
a nickel foam substrate; and
a layer of particles of manganese oxide having a formula of MnₓO_{y} on a surface of the nickel foam substrate,
wherein x is an integer from 1 to 7,
wherein y is an integer from 1 to 13,
wherein the particles of MnO have a spherical shape with an average diameter of 5-15 nanometers (nm),
wherein the particles of MnO are aggregated with an average aggregate size of 500-1,000 nm in the shape of a cauliflower.

2: The method of claim 1, further comprising:
forming the electrocatalyst by:
mixing a manganese salt in a solvent to form a homogeneous solution; and
depositing the homogeneous solution on the nickel foam substrate by aerosol-assisted chemical vapor deposition (AACVD) at a temperature of 400-600° C. to form the electrocatalyst.

3: The method of claim 2, wherein the depositing is carried out for 30-60 minutes.

4: The method of claim 2, wherein the depositing is carried out at atmospheric pressure.

5: The method of claim 1, wherein the particles of manganese oxide have a formula of MnO.

6: The method of claim 5, wherein the MnO has a cubic structure having a space group of Fm3m.

7: The method of claim 5, wherein the MnO is polycrystalline.

8: The method of claim 1, wherein the particles of manganese oxide consist of Mn and O.

9: The method of claim 1, wherein the particles of manganese oxide are homogeneously dispersed on the surface of the nickel foam substrate.

10: The method of claim 1, wherein the particles of manganese oxide cover an entire surface of the nickel foam substrate.

11: The method of claim 1, wherein the particles of manganese oxide penetrate micropores of the nickel foam substrate.

12: The method of claim 1, wherein the particles of manganese oxide form a continuous network on the surface of the nickel foam substrate.

13: The method of claim 1, wherein the electrocatalyst has an overpotential of 140-160 millivolts (mV) for a current density of 10 milliampere per square centimeter (mA cm⁻²).

14: The method of claim 13, wherein the overpotential does not vary by more than 5% after the potential is applied for 2-50 hours.

15: The method of claim 1, wherein the electrocatalyst has a current density of at least 1,000 mA cm⁻² at 430 mV.

16: The method of claim 1, wherein the electrocatalyst has an electrochemical surface area of 120-160 cm².

17: The method of claim 1, wherein the electrocatalyst consists of the particles of manganese oxide on the surface of the nickel foam substrate.

18: The method of claim 1, wherein the aqueous solution comprises at least one base selected from the group consisting of an alkaline earth metal hydroxide and an alkali metal hydroxide.

19: The method of claim 18, wherein the base is potassium hydroxide.

20: The method of claim 1, wherein the counter electrode is made from a material selected from the group consisting of platinum, gold, and carbon.
